(19) United States
(12) Patent Application Publication
(10) Pub. No.: US 2014/0036773 A1
(43) Pub. Date: Feb. 6, 2014

(54) Session Management procedures for transferring data

(71) Applicant: Dan Ibrahim Fogbel, Newbury (GB)

(72) Inventor: Dan Ibrahim Fogbel, Newbury (GB)

(21) Appl. No.: 13/931,965

(22) Filed: Jun. 30, 2013

(30) Foreign Application Priority Data
Jul. 31, 2012 (GB) GB1213638.8

(51) Int. Cl. H04W 76/02

(52) U.S. Cl. CPC H04W 76/02
USPC 370/328

(57) ABSTRACT

Method for transferring user data from one or more user equipment (UE) over a telecommunications network to customer network(s). The UE inserts the user data in session management signalling message(s) before transmitting the session management message(s) containing the user data over the signalling plane of a telecommunications network. On the customer network, the user data is retrieved by extracting the user data from one ore more authentication, authorization and accounting (AAA) protocol message(s) sent from the telecommunications network to the customer network.

### FIELD OF THE INVENTION

This invention presents a method for transferring user data from any type of User Equipment (UE) (i.e. Machine to Machine units) over a telecommunications network signalling plane using session management signalling procedures and authentication, authorization and accounting (AAA) protocol message(s).

The UE inserts the user data in session management signalling message(s) before transmitting the session management message(s) containing the user data over the signalling plane of a telecommunications network. On the customer network, the user data is retrieved by extracting the user data from one ore more AAA protocol message(s) sent from the telecommunications network to the customer network.

“Customer network” refers to, for example, one or more computer network(s), home network(s), enterprise network(s), internet/network hosts or any types of computer network, host(s), subsystem(s) element(s) and or stand-alone server(s) setup inside or outside the telecommunications network domain.

The AAA protocol may be for example, Radius protocol, TACACS protocol, TACACS+ protocol or any other AAA/Diameter based protocols and the like.

### BACKGROUND OF THE INVENTION

Machine to Machine (M2M) communication is a rapidly emerging way of systems automation and data-exchange between devices. It provides the means of accessing and or controlling hundreds of thousands of remotely located machines from one or more central point(s). M2M communication is also referred to as Machine Type Communications or MTC.

M2M units can be integrated into virtually any system i.e. Power-meters/Smart-meters, vending-machines, track-n-trace devices, windmills, surveillance systems, vehicles etc. M2M units enable devices to actively communicate with a central system for remote management or data collation.

A smart-meter that transmits power-usage information to a power company or a vending machine that automatically sends an alert to the operator/supplier when it is running out of supplies are examples of M2M communications.

M2M units typically send small amount of (user) data at fixed/regular intervals. User data sent from a UE such as, for example, a M2M communication unit may contain GPS coordinates (i.e. latitude/longitude), telemetric data, user data collated from several devices, device health status, protocol data, application data, etc.

A user equipment (UE) may consists of, and or may be part of one or more of the following; a communication module, a Terminal Equipment (TE), a Mobile Station (MS), a Smart Phone, a Personal Digital Assistant (PDA), a Personal Computer (PC), a Server, a Smart Television, an M2M communication unit, a Laptop/Notebook computer and the like. A UE may further consist of an integrated and or an external transmitter/transceiver used to connect the UE to a wireless interface, (i.e. air interface), or a wired interface (i.e. modem line).

### BRIEF SUMMARY OF THE INVENTION

This invention provides a method for transferring user data from a UE over the signalling plane of a telecommunications network to a customer network.

As defined in the 3GPP Technical Specifications for GSM, UNITS, LTE and the like, there are several types of signalling protocols/procedures used in a telecommunications network. For example, Mobility Management (MM), Session Management (SM), Call Control (CC), Short Message Service (SMS), etc.

This invention specifically involves transferring user data using session management signalling protocols/procedures and or authentication, authorization and accounting (AAA) protocol messages.

An aspect of the invention, as provided by claims 1-3, involves a UE intelligently inserting user data in session management signalling message(s) in a way that the integrity of the session management signalling message(s) are kept intact to remain transparent to the transit (telecommunications) network(s). This invention presents a user data transfer method that is transparent to the telecommunications network.

The method adapts session management signalling protocol messages to make it possible to transfer user data using the session management protocol over a telecommunications network. There are no additional nodes required (in a typical mobile data network setup) in the home telecommunications network. This method also makes it possible for the UE to transfer user data to the customer network while roaming nationally or internationally without the need to deploy additional nodes or require network re-configuration in the foreign/national roaming telecommunications networks where the UE may be roaming.

Another aspect of the invention, as provided by claim 4-12, relates to the UE transmitting the session management signalling message(s) (containing the user data) to a telecommunications network over the signalling plane of the telecommunications network. As provided by claim 8, the user data may be inserted with or without some form of data security applied to it prior to the user data being inserted into the session management signalling message(s).

Yet other aspects of the invention, as provided by claims 2, 3, 13 and 14, involve network host(s) (i.e. AAA server) on the customer network, retrieving the user data from one or more AAA protocol message(s) sent from the telecommunications network to the customer network and confirming to the UE whether or not the user data inserted in the session management signalling message(s) was successfully retrieved.

The UE is designed and or (re)configured and or (re)programmed to perform the step(s) of inserting user data m the session management signalling message(s) before transmitting the session management signalling message(s) containing the user data to the telecommunications network.

The user data may be inserted in one or more Information Element (IF) of a single or series of session management signalling message(s); such as, for example, in the value field of: Internet Protocol Address (i.e. IPv6 address) IE, Protocol Configuration Option (PCO) IE, sub IEs, attributes, etc. As an example the username and password value fields/attributes within the (sub) IE of the PCO may be used for authenticating the UE and or holding at least part of the user data inserted in the session management signalling message(s).

The session management signalling message(s), as provided by claim 4-12, for transferring user data from a UE may be one or series of an ACTIVATE PDP CONTEXT REQUEST, a PDN CONNECTIVITY REQUEST or an ESM INFORMATION RESPONSE.

As provided by claims 2 and 3, the user data is retrieved on the customer network by extracting/retrieving the user data from one or more AAA protocol message(s) received from the telecommunications network.

As provided by claims 13 and 14, the entire AAA protocol message(s) or part of the AAA protocol message(s) or only the extracted user data may be, for example, forwarded, logged, processed, stored, or used as data feed for a variety of other internal or external applications, databases, servers, networks, stand-alone server(s), host(s), etc.

### BRIEF DESCRIPTION OF THE DRAWINGS

The drawings disclose the preferred session management dialogs used to transfer user data between the UE and the telecommunications network(s). The drawings also disclose the preferred AAA dialogs used to transfer user data between the telecommunications network and the customer network.

A telecommunications network may comprise of one or more of the following network standards, access types and technologies: 2G-GSM/GPRS, 2.5G-EDGE, 3G-UMTS/HSPA/HSPA+, 4G-LTE/WIMAX, or any other derivatives hereof.

FIG. 1 discloses the method for transferring user data using session management signalling message(s) for a 2G/3G network attached UE. The flow diagram provides the PDP context activation (session management) message flow for transferring user data from a UE, through the signalling plane of a telecommunications network to a customer network and a method for confirming to the UE whether or not the user data was successfully retrieved by the customer network.

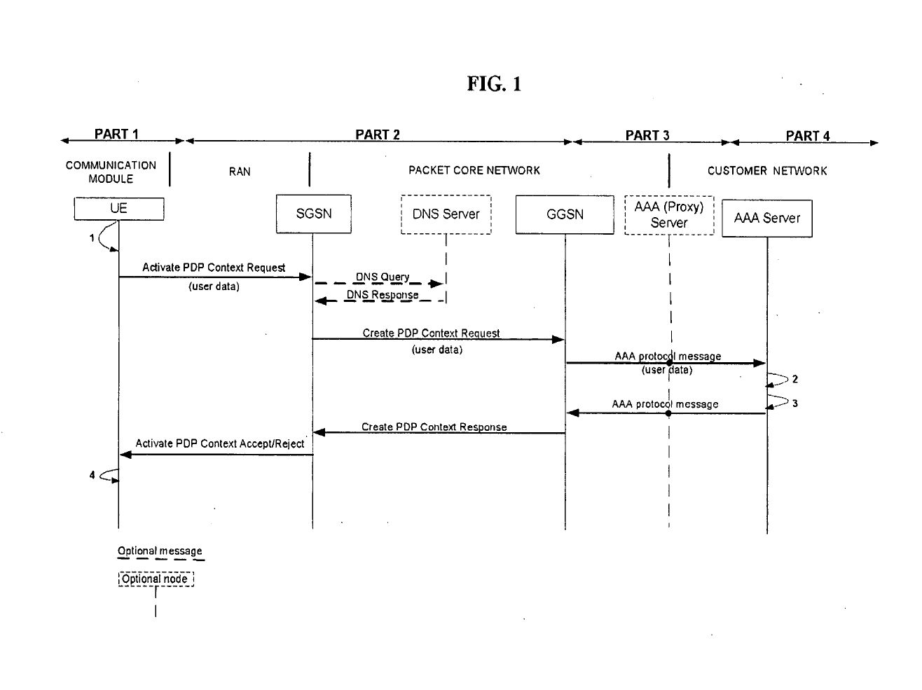

FIG. 2 discloses the method for transferring user data using session management signalling message(s) for an attached UE in an evolved 2G/3G network. The flow diagram provides the PDP context activation (session management) message flow for transferring user data from a UE, through the signalling plane of a telecommunications network to a customer network and a method for confirming to the UE whether or not the user data was successfully retrieved by the customer network.

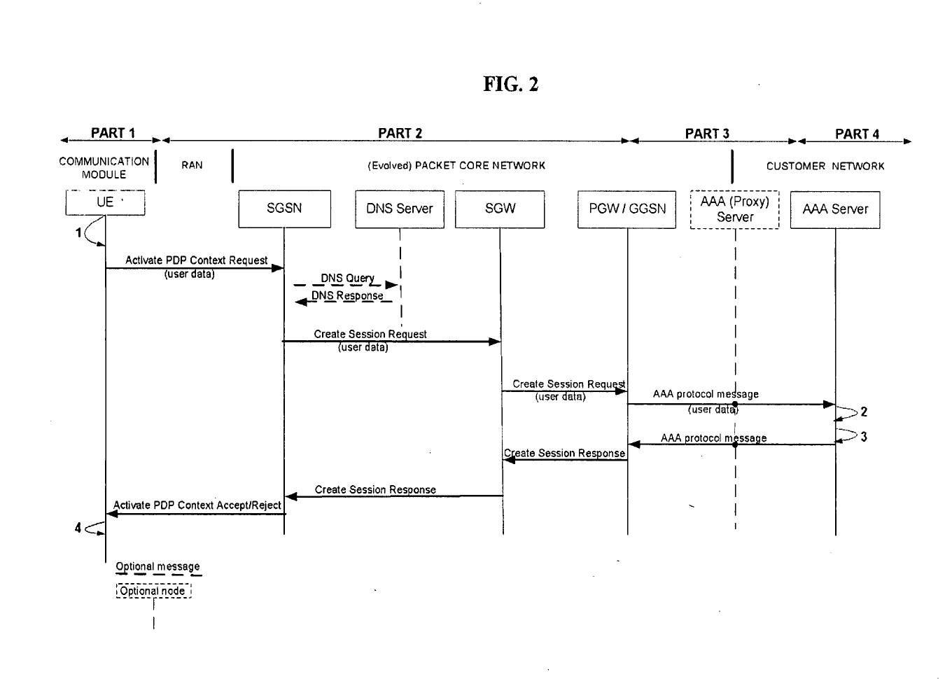

FIG. 3 discloses the method for transferring user data using session management signalling message(s) for a 4G capable UE. The flow diagram provides a (stand-alone or combined) PDN connectivity request (session management) message flow for transferring user data from a UE, through the signalling plane of a telecommunications network to a customer network and a method for confirming to the UE whether or not the user data was successfully retrieved by the customer network.

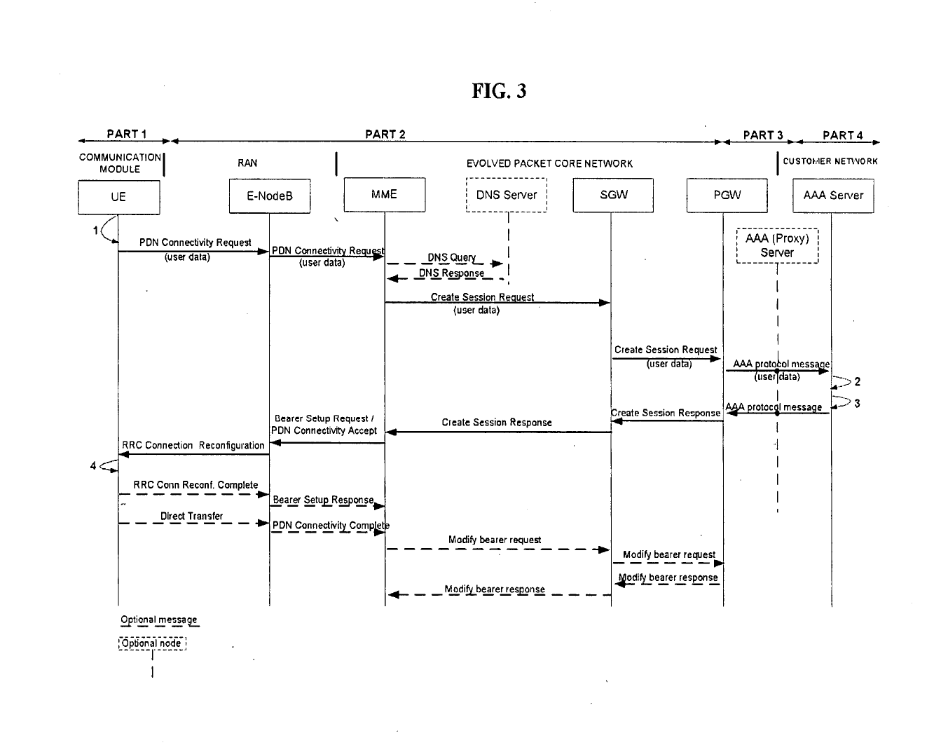

FIG. 4 discloses the method for transferring user data using session management signalling message(s) for a 4G capable UE. The flow diagram provides an ESM information request/response (session management) message flow for transferring user data from a UE, through the signalling plane of a telecommunications network to a customer network and a method for confirming to the UE whether or not the user data was successfully retrieved by the customer network.

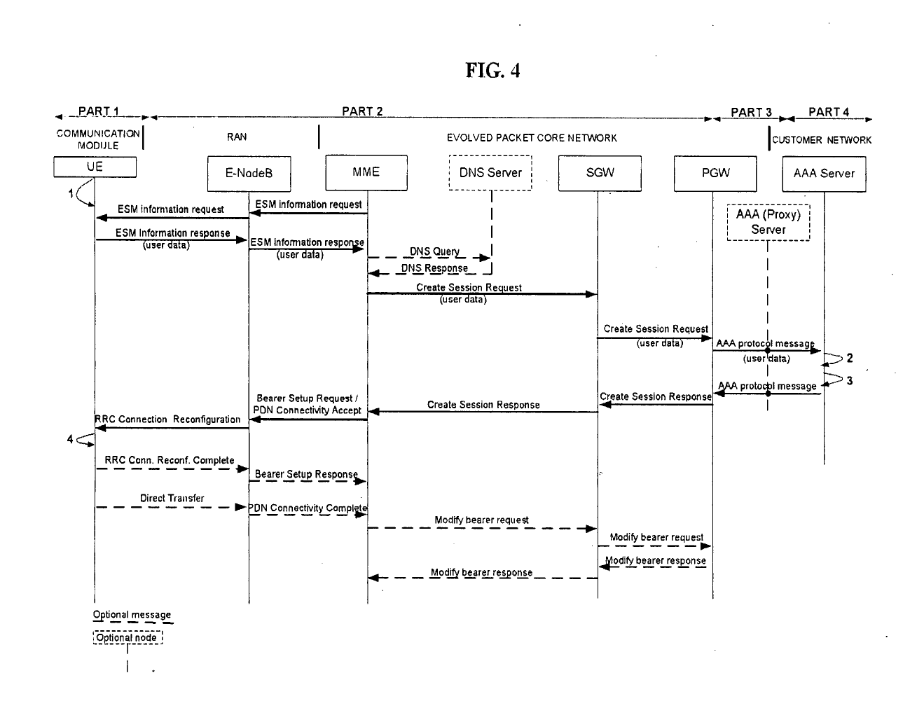

### DETAILED DESCRIPTION OF THE INVENTION

The figures provide certain embodiments of the present invention, and disclose the general processes and message flows of the present invention. For clarity purposes the processes and message flows are divided into four major parts.

As known to those skilled in the art, a telecommunications network further includes radio access network (RAN) subsystem element(s) (not shown for clarity purposes). RAN subsystem element(s) may be for example BSC, RNC, Node-B, BTS etc responsible for setting up and controlling the access network communication channels. The packet core and or evolved packet core network structure may vary per telecommunications network provider.

### Part 1

When it is time for the UE to transfer user data to a customer network (i.e. after an internal or external event such as location change, threshold event, sensor event, time interval trigger, etc), for the purpose of transferring user data to, for example, a customer network, the UE initiates the process of inserting said user data in session management signalling message(s) 1.

The session management signalling message(s) may be a single or multiple instances (in any combination) of an ACTIVATE PDP CONTEXT REQUEST message, a PDN CONNECTIVITY REQUEST message or an ESM INFORMATION RESPONSE message. These message(s) may be used separately or combined (in any combination) and transmitted concurrently or sequentially for the transfer of user data from the UE to for example a customer network.

The UE may insert the user data in the value field of the Information Element (IE) and or sub IE of, for example, protocol configuration option information element(s) (PCO IE) of the session management signalling message(s). After inserting the user data in the session management signalling message(s), the UE initiates a session management procedure to the telecommunications network by transmitting the session management signalling message(s) containing the user data to the telecommunications network.

In the preferred embodiment of the invention, the UE is programmed/configured to initiate PDP/PDN contexts using a customer specific (private) Access Point Name (APN) to which it is subscribed in the home telecommunications network.

### Part 2

The telecommunications network regards the incoming session management signalling message(s) as a regular session management signalling message(s) and performs the standard procedures (amongst others, GGSN/PGW selection based on supplied APN, default APN or converted APN).

In the preferred embodiment of the invention, the (home) telecommunications network gateway nodes (i.e. GPRS Gateway Support Node [GGSN] and or PDN Gateway [PGW]) are configured to authenticate all users (attempting to setup a PDP/PDN context) against the designated AAA server on the customer network.

### Part 3

The (evolved) packet core nodes (i.e. GGSN/PGW) generate one or more AAA protocol message(s) such as, for example, RADIUS ACCESS REQUEST message(s) (with said user data inserted in i.e. one or more attribute value pair [AVP] or Vendor Specific Attribute [VSA] of the message) and transmits the AAA protocol message(s) to the customer network.

The AAA protocol message(s) may be transmitted directly to the customer network or via one or more intermediate AAA server(s) and or AAA proxy server(s). The AAA protocol message(s) may be transmitted to the customer network through, for example, LAN, WAN, leased lines, VPN, internet connections, etc.

### Part 4

On the customer network, the user data is retrieved by extracting the user data from one or more AAA protocol message(s) sent from the telecommunications network to the customer network 2.

The entire AAA protocol message(s) or part of the AAA protocol message(s) or only the extracted user data may be, for example, forwarded, logged, processed, stored, or used as data feed for a variety of other internal or external applications, databases, servers, networks, stand-alone server(s), host(s), etc. 2.

To acknowledge the successful retrieval or non successful retrieval of the user data from the AAA protocol message(s), the customer network (AAA Server) may transmit an AAA protocol reject message(s) to the telecommunications network if it detects that the user data could not be retrieved from the AAA protocol message(s) received from the telecommunications network 3.

Further, the AAA protocol response message(s) seat from the customer network to the telecommunications network may trigger the telecommunications network to send i.e. an “Activate PDP context reject” or a “PDN connectivity reject” message back to the UE in response to the session management procedure initiated by the later.

The UE may derive from the response received from the telecommunication network whether or not the user data was successfully retrieved from the session management signalling message(s) 4 by the customer network. The UE may re-initiate the transfer of at least part of the user data previously transmitted in one or more session management protocol message(s) 1 if it detects from the response that the user data could not be retrieved by the target network, i.e. the customer network 4.

1. A method for transferring user data from a UE over a telecommunications network to a customer network, the method comprising the steps in the UE of:
inserting user data in session management signalling message(s) and transmitting said session management signalling message(s) containing said user data to a telecommunications network.

2. The method according to claim 1 further comprising the steps of:
said telecommunications network configured to perform the steps of transmitting AAA protocol message(s) containing said user data to said customer network.

3. The method according to claim 2 further comprising the steps of:
said customer network, configured to perform the steps of retrieving and or processing and or logging and or forwarding at least part of the said AAA protocol message(s) containing said user data.

4. The method according to claim 1 wherein said session management signalling message(s) containing said user data is one or more ACTIVATE PDP CONTEXT REQUEST.

5. The method according to claim 1 wherein said session management signalling message(s) containing said user data is one or more stand alone PDN CONNECTIVITY REQUEST.

6. The method according to claim 1 wherein said session management signalling message(s) containing said user data is one or more combined PDN CONNECTIVITY REQUEST.

7. The method according to claim 1 wherein said session management signalling message(s) containing said user data is one or more ESM INFORMATION RESPONSE.

8. The method according to claim 1 wherein at least a part of said user data is compressed and or hashed and or encoded and or scrambled and or encrypted.

9. A UE and or a peripheral connected to the UE configured to insert user data in session management signalling message(s) according to claim 4.

10. A UE and or a peripheral connected to the UE configured to insert user data in session management signalling message(s) according to claim 5.

11. A UE and or a peripheral connected to the UE configured to insert user data in session management signalling message(s) according to claim 6.

12. A UE and or a peripheral connected to the UE configured to insert user data in session management signalling message(s) according to claim 7.

13. The method according to claim 2 further comprising one or more hosts internal or external to a customer network configured to perform the steps of retrieving user data from AAA protocol message(s) sent from a telecommunications network.

14. The method according to claim 13 wherein said host(s) are configured to perform the steps of retrieving user data from data logs and or data files and or database(s) and or system memory and or application message(s) containing at least part of the AAA protocol message(s) sent from a telecommunications network.
